(19) United States
(12) Patent Application Publication
(10) Pub. No.: US 2025/0204551 A1
(43) Pub. Date: Jun. 26, 2025

(54) FUNCTIONAL PLANT-BASED MATERIALS

(71) Applicant: Purdue Research Foundation, West Lafayette, IN (US)

(72) Inventor: Yuan Yao, West Lafayette, IN (US)

(21) Appl. No.: 18/984,409

(22) Filed: Dec. 17, 2024

Related U.S. Application Data
(60) Provisional application No. 63/612,846, filed on Dec. 20, 2023.
(60) Provisional application No. 63/613,433, filed on Dec. 21, 2023.

(51) Int. Cl. A23J 3/14; A23K 10/30; A23K 20/163; A23K 20/189; A23L 29/00; A23L 29/262

(52) U.S. Cl. CPC A23J 3/14; A23K 10/30; A23K 20/163; A23K 20/189; A23L 29/06; A23L 29/262

(57) ABSTRACT

An aqueous dispersion of a shear-processed, plant-based protein; a shear-processed, plant-based protein and human food and animal feed products comprising same; and a composition comprised of at least one herb-spice with anti-pathogen and/or anti-spoilage properties and subjected to a high shear treatment and human food and animal feed products comprising same, alone or in further combination with an aforementioned shear-processed, plant-based protein.

### CROSS-REFERENCE TO RELATED APPLICATIONS

This application claims priority to U.S. provisional patent application No. 63/612,846, which was filed Dec. 20, 2023, and U.S. provisional patent application No. 63/613,433, which was filed Dec. 21, 2023, both of which are hereby incorporated by reference in their entireties.

### APPENDIX

This application is accompanied by an Appendix (70442-03 appendix FINAL), which is hereby incorporated by reference in its entirety.

### TECHNICAL FIELD

The present disclosure relates to shear-processed, plant-based protein and/or herb or spice and their applications in food and non-food areas, in particular plant-based meat alternative (PBMA) products. The shear-processed, plant-based protein can be used as binder in food and non-food systems. The shear-processed herb or spice can be used as an antimicrobial agent in food and non-food systems. The shear-related methods used to generate shear-processed, plant-based protein and/or herb or spice include, but are not limited to, homogenization, milling, kneading, and extrusion.

### BACKGROUND

Many food and non-food consumer products need natural, non-artificial ingredients while maintaining their quality and shelf life. These products need to not only address consumers' demand for high quality and affordability but also benefit or support social and environmental sustainability. For instance, plant-based meat alternative (PBMA) products, which have entered the mainstream consumer markets, have strong needs for using natural ingredients to maintain or increase their food quality (e.g., texture, flavor, nutrition) and food safety against pathogenic and/or spoilage microorganisms.

In view of the above, there is an unmet need for products that better address consumers' demands. It is an object of the present disclosure to provide a plant-based protein binder for texture enhancement, while reducing or eliminating the need for using methylcellulose and/or transglutaminase, and to provide an herb and/or spice (“herb-spice” is used herein to indicate herb and/or spice) composition with sufficient antimicrobial properties to prolong the shelf life of products. The binder and the herb-spice composition can be used individually or combined. Other objects and advantages, as well as inventive features, will be apparent from the detailed description provided herein.

### SUMMARY

An aqueous dispersion of a shear-processed, plant-based protein is provided. When the pH of the aqueous dispersion is about 4.5 to about 8, the shear-processed, plant-based protein forms particles or aggregates with a Z-average particle size greater than 500 nm. In certain embodiments, the plant-based protein is pea protein. The plant-based protein is prepared using a process comprising a high-shear treatment. The high-shear treatment can be homogenization, milling, kneading, extrusion, or a combination of two or more thereof.

Also provided is a shear-processed, plant-based protein, which, when dispersed in an aqueous solvent at a pH of about 4.5 to about 8, forms particles or aggregates with a Z-average particle size greater than 500 nm. In certain embodiments, the plant-based protein is pea protein. The plant-based protein is prepared using a process comprising a high-shear treatment. The high-shear treatment can be homogenization, milling, kneading, extrusion, or a combination of two or more thereof.

Also provided is a shear-processed, plant-based protein, which, when dispersed in an aqueous solvent at a pH of about 4.5 to about 7, forms particles or aggregates with a Z-average particle size greater than that of the plant-based protein without being shear-processed.

Also provided is a shear-processed, plant-based protein, which, when dispersed in an aqueous solvent at a pH of about 4.5 to about 7, forms particles or aggregates with a Z-average particle size of at least 10, 100, 200, 500, 1000, or 2000 nm greater than that of the plant-based protein without being shear-processed.

Also provided is a shear-processed, plant-based protein, which shows the hydrophobic index greater than that of the plant-based protein without being shear-processed.

Also provided is a shear-processed, plant-based protein, which shows the hydrophobic index at least 1.1, 1.2, or 1.5 times that of the plant-based protein without being shear-processed (FIG. 1). The hydrophobic index can be determined using various approaches, including but not limited to 1-anilinonaphthalene-8-sulfonic acid (ANS) method (FIG. 1).

Also provided is a shear-processed, plant-based protein, which shows the hydrophobic index at least 0.1, 0.2, or 0.5 times greater than that of the plant-based protein without being shear-processed (FIG. 1). The hydrophobic index can be determined using various approaches, including but not limited to 1-anilinonaphthalene-8-sulfonic acid (ANS) method (FIG. 1).

Also provided is a shear-processed, plant-based protein, which, when used in a PBMA product as a binder, can significantly increase the integrity and/or flexibility of the product, as compared with the plant-based protein without being shear-processed.

The integrity and/or flexibility of the product can be determined using various approaches, including but not limited to: (1) sensory evaluations on the texture of product, (2) textural analysis including but not limited to texture profile analysis and/or three-point bend test. In textural analysis, the integrity and/or flexibility can usually be indicated as the maximal travel distance of probe without breaking the testing sample of product. For example, in the three-point bend test, the maximal travel distance of probe is the distance till break point (FIG. 3).

Also provided is a shear-processed, plant-based protein, which, when used in a PBMA product as a binder, can significantly increase the distance till break point of the PBMA product in a three-point bend test, as compared with the plant-based protein without being shear-processed.

During a three-point bend test, the PBMA product formulated using a shear-processed, plant-based protein as a binder, can achieve the distance till break point of at least 1.05, 1.1, 1.2, 1.3, 1.4, 1.5, 1.6, 1.7, 1.8, 1.9, 2.0, 2.2, 2.5, or 3.0 times that of the PBMA product formulated using the same amount of plant-based protein without being shear-processed.

Also provided is a shear-processed, plant-based protein, which, when used in a PBMA product as a binder, can achieve the distance till break point of the PBMA product in a three-point bend test of at least 1.05, 1.1, 1.2, 1.3, 1.4, 1.5, 1.6, 1.7, 1.8, 1.9, 2.0, 2.2, 2.5, or 3.0 times that of the plant-based protein without being shear-processed.

Also provided is a shear-processed, plant-based protein, which, when used in a PBMA product as a binder, can increase the distance till break point of the PBMA product in a three-point bend test by at least 0.05, 0.1, 0.2, 0.3, 0.4, 0.5, 0.6, 0.7, 0.8, 0.9, 1.0, 1.2, 1.5, or 2.0 times, as compared with the plant-based protein without being shear-processed.

In certain embodiments, the plant-based protein is pea protein.

The plant-based protein is prepared using a process comprising a shear or high-shear treatment. The shear or high-shear treatment can be homogenization, milling, kneading, extrusion, or a combination of two or more thereof. The shear or high-shear treatment transfers a plant-based protein into a shear-processed, plant-based protein.

In view of the above, a human food or animal feed product comprising the shear-processed, plant-based protein is provided. In certain embodiments, the product is a plant-based meat alternative product. The product either (i) comprises a reduced amount of methylcellulose (or other polysaccharide gum), a crosslinking enzyme (e.g., transglutaminase), or both, where “reduced” refers to a decrease of at least about 5%, 10%, 20%, 40%, or 80% compared with products without said shear-processed, plant-based protein, or (ii) does not comprise methylcellulose (or other polysaccharide gum), a crosslinking enzyme (e.g., transglutaminase), or both.

Usually, the activity of a component, a compound, a material, a composition, an ingredient, or a formulation to reduce, inhibit, kill, and/or eliminate a pathogenic microorganism or a spoilage microorganism is called an anti-pathogen property (or capability) or an anti-spoilage property (or capability).

Further provided is a composition comprising at least one herb-spice with anti-pathogen property and/or anti-spoilage property, wherein, by shear processing, (i) the content of pathogenic microorganisms and/or spoilage microorganisms of the at least one herb-spice is decreased, (ii) the anti-pathogen property and/or anti-spoilage property of the at least one herb-spice is increased, or (iii) the content of pathogenic microorganisms and/or spoilage microorganisms of the at least one herb-spice is decreased, and the anti-pathogen property and/or anti-spoilage property of the at least one herb-spice is increased.

The shear processing can cause at least 1, 2, 3, 4, or 5 log reduction of pathogenic microorganisms and/or spoilage microorganisms. In certain embodiments, the at least one herb-spice is a whole spice. The shear processing can involve homogenization, milling, kneading, extrusion, or a combination of two or more thereof.

The at least one herb-spice can have anti-pathogen and/or anti-spoilage properties against Listeria, E. coli, Salmonella, or their combinations, as well as other types of pathogenic or spoilage microorganisms. In certain embodiments, the at least one herb-spice can decrease the amount of pathogenic or spoilage microorganisms by at least 90, 99, 99.9, or 99.99%, corresponding to 1, 2, 3, or 4 log reduction. In certain embodiments, the at least one herb-spice is oregano, rosemary, garlic, onion, allspice, oregano, thyme, cinnamon, tarragon, cumin, cloves, lemongrass, bay leaf, capsicum, marjoram, mustard, caraway, mint, sage, fennel, coriander, dill, nutmeg, basil, parsley, cardamon, pepper, ginger, anise seed, celery seed, lemon, lime, huacatay, turmeric, or a combination of two or more of the foregoing. In certain other embodiments, the at least one herb-spice is rosemary, cloves, and/or cinnamon.

In view of the above, further provided is a product, such as a product for human or animal consumption as described above, further comprising the composition comprising at least one herb-spice with anti-pathogen and/or anti-spoilage properties. In certain embodiments, the composition comprising at least one herb-spice with anti-pathogen and/or anti-spoilage properties is present in an amount up to 5% by weight of the product.

### BRIEF DESCRIPTION OF THE FIGURES

FIG. 1 is a graph of relative fluorescence index (RFI) vs. protein concentration (mg/mL), which shows the corrected RFI of two physically processed pea protein isolate (PPPP) materials (PPPP #1 and PPPP #10) and non-treated pea protein isolate (non-treated PP). Label “a/b-x/y” after PPPP #1 or #10 indicates that the pea protein isolate was subjected to high-pressure homogenization at “a” bars for “b” passes, then spray-dried at an inlet temperature of x° C. and outlet temperature of y° C. The test used 1-anilinonaphthalene-8-sulfonic acid (ANS) as a hydrophobic probe. The hydrophobic index (slope of linear trendline of RFI vs. protein concentration data points) of each protein was 93.3, 82.8, and 44.5 for PPPP #1, PPPP #10, and non-treated PP, respectively.

FIG. 2 is a graph of means of Z-average particle size (d.nm) vs. PPPP, which shows the Z-average particle size of physically processed pea protein isolate (PPPP) at different pH conditions. Label “a/b-x/y” after each of PPPP #1 to #11 indicates that the pea protein isolate was subjected to high-pressure homogenization at “a” bars for “b” passes, then spray-dried at an inlet temperature of x° C. and outlet temperature of y° C. For each pH value, the significant differences among the Z-average particle size are labeled using different letters (n=9, P<0.05).

FIG. 3 (top) shows the peak force (g) of raw, uncooked and cooked and cooled to room temperature samples when subjected to 3-point bend test. FIG. 3 (bottom) shows the distance till break point (mm) of raw, uncooked and cooked and cooled to room temperature samples when subjected to 3-point bend test. MC: methylcellulose. PPPP #1: physically processed pea protein isolate prepared through subjecting pea protein isolate to high-pressure homogenization at 200 bars for 2 passes, then spray-dried at an inlet temperature of 120° C. and outlet temperature of 65° C.

FIG. 4 shows images of PBMA patties with 2% methylcellulose (MC), 10% non-treated PP, 10% PPPP #1, 9% PPPP #1 and 1% milled rosemary, 9.5% PPPP #1 and 0.5% milled rosemary, or 9.5% PPPP #1 and 0.5% milled cinnamon as binder.

FIG. 5 shows the SEM images of uncooked and cooked PBMA patties with 2% MC, 10% non-treated PP, or 10% PPPP #1 as binder.

### DETAILED DESCRIPTION

The present disclosure is predicated, at least in part, on the discovery of a plant-based protein binder, which reduces or eliminates the need for methylcellulose (or other polysaccharide gums) and/or a cross-linking enzyme, such as transglutaminase. The binder helps maintain or increase the protein content and the texture of food products, such as plant-based meat alternative (PBMA) products. The present disclosure is also predicated on the discovery of an herb-spice composition with increased antimicrobial properties. The herb-spice composition reduces the growth of pathogenic and/or spoilage microorganisms during production, transportation, storage, and consumption of food products, such as PBMA products.

In view of the above, provided is an aqueous dispersion of a shear-processed, plant-based protein. In this document, the term “plant-based protein” includes plant-based protein isolate such as pea protein isolate and soy protein isolate, plant-based protein extract such as pea protein extract and soy protein extract, or other compositions that contain plant-based protein. When the pH of the aqueous dispersion is about 4.5 to about 8, the shear-processed, plant-based protein forms particles or aggregates with a Z-average particle size greater than 500 nm. In certain embodiments, the plant-based protein is pea protein. In embodiments, the plant-based protein is prepared using a process comprising a high-shear treatment. In embodiments, the high-shear treatment is homogenization, milling, kneading, extrusion, or a combination of two or more thereof.

Also provided is a shear-processed, plant-based protein, which, when dispersed in an aqueous solvent at a pH of about 4.5 to about 8, forms particles or aggregates with a Z-average particle size greater than 500 nm. In certain embodiments, the plant-based protein is pea protein isolate. In embodiments, the shear-processed, plant-based protein is prepared using a process comprising a high-shear treatment. In embodiments, the high-shear treatment is homogenization, milling, kneading, extrusion, or a combination of two or more thereof. In various embodiments, the shear-processed, plant-based protein has increased hydrophobicity and reduced solubility, both of which can lead to greater particle size and increased aggregation. The shear-processed, plant-based protein can be in the form of a liquid, a semi-liquid, or a solid.

The protein material (e.g., protein isolate, protein extract) to be subjected to shear processing can be obtained from various sources and in various forms, including but not limited to: (1) an aqueous protein-containing dispersion directly obtained from a protein extraction process, and (2) an aqueous protein dispersion prepared through dispersing a protein (isolate or extract) solid, semi-solid, semi-liquid, or liquid in an aqueous solvent.

Also provided is a shear-processed, plant-based protein, which, when dispersed in an aqueous solvent at a pH of about 4.5 to about 7, forms particles or aggregates with a Z-average particle size greater than that of the plant-based protein without being shear-processed.

Also provided is a shear-processed, plant-based protein, which, when dispersed in an aqueous solvent at a pH of about 4.5 to about 7, forms particles or aggregates with a Z-average particle size of at least 10, 100, 200, 500, 1000, or 2000 nm greater than that of the plant-based protein without being shear-processed.

Also provided is a shear-processed, plant-based protein, which shows the hydrophobic index greater than that of the plant-based protein without being shear-processed.

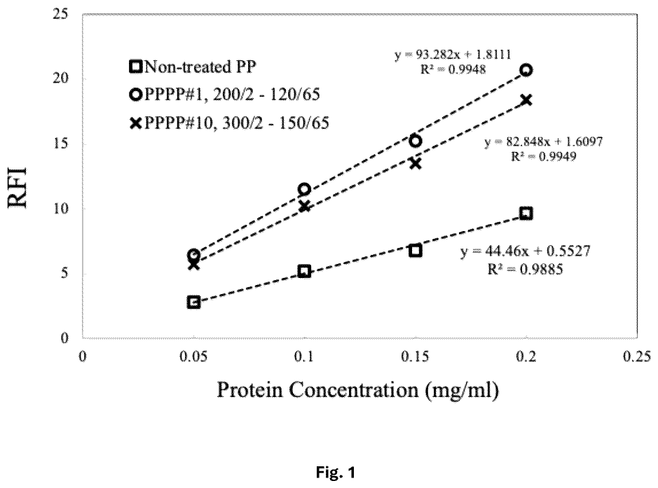

Also provided is a shear-processed, plant-based protein, which shows the hydrophobic index at least 1.1, 1.2, or 1.5 times that of the plant-based protein without being shear-processed (FIG. 1). The hydrophobic index can be determined using various approaches, including but not limited to 1-anilinonaphthalene-8-sulfonic acid (ANS) method (FIG. 1).

Also provided is a shear-processed, plant-based protein, which shows the hydrophobic index at least 0.1, 0.2, or 0.5 times greater than that of the plant-based protein without being shear-processed (FIG. 1). The hydrophobic index can be determined using various approaches, including but not limited to 1-anilinonaphthalene-8-sulfonic acid (ANS) method (FIG. 1).

Also provided is a shear-processed, plant-based protein, which, when used in a PBMA product as a binder, can significantly increase the integrity and/or flexibility of the product, as compared with the plant-based protein without being shear-processed.

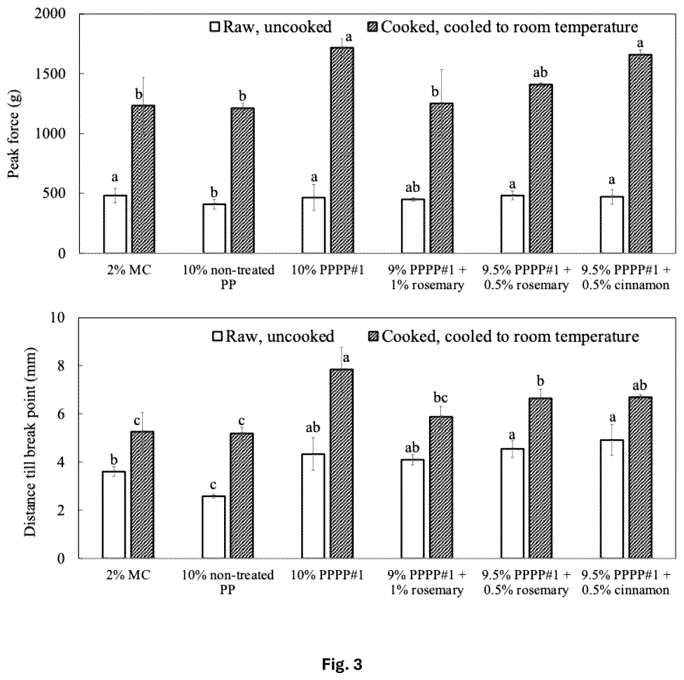

The integrity and/or flexibility of the product can be determined using various approaches, including but not limited to: (1) sensory evaluations on the texture of product, (2) textural analysis including but not limited to texture profile analysis and/or three-point bend test. In textural analysis, the integrity and/or flexibility can usually be indicated as the maximal travel distance of probe without breaking the testing sample of product. For example, in the three-point bend test, the maximal travel distance of probe is the distance till break point (FIG. 3).

Also provided is a shear-processed, plant-based protein, which, when used in a PBMA product as a binder, can significantly increase the distance till break point of the PBMA product in a three-point bend test, as compared with the plant-based protein without being shear-processed.

During a three-point bend test, the PBMA product formulated using a shear-processed, plant-based protein as a binder can achieve the distance till break point of at least 1.05, 1.1, 1.2, 1.3, 1.4, 1.5, 1.6, 1.7, 1.8, 1.9, 2.0, 2.2, 2.5, or 3.0 times that of the PBMA product formulated using the same amount of plant-based protein without being shear-processed.

Also provided is a shear-processed, plant-based protein, which, when used in a PBMA product as a binder, can achieve the distance till break point of the PBMA product in a three-point bend test of at least 1.05, 1.1, 1.2, 1.3, 1.4, 1.5, 1.6, 1.7, 1.8, 1.9, 2.0, 2.2, 2.5, or 3.0 times that of the plant-based protein without being shear-processed.

Also provided is a shear-processed, plant-based protein, which, when used in a PBMA product as a binder, can increase the distance till break point of the PBMA product in a three-point bend test by at least 0.05, 0.1, 0.2, 0.3, 0.4, 0.5, 0.6, 0.7, 0.8, 0.9, 1.0, 1.2, 1.5, or 2.0 times, as compared with the plant-based protein without being shear-processed.

In certain embodiments, the plant-based protein is pea protein.

The plant-based protein is prepared using a process comprising a shear or high-shear treatment. The shear or high-shear treatment can be homogenization, milling, kneading, extrusion, or a combination of two or more thereof. The shear or high-shear treatment transfers a plant-based protein into a shear-processed, plant-based protein.

The plant-based protein can be obtained from any plant or part thereof, such as legumes (Leguminosae or Fabaceae) including beans, peas, chickpeas, southern peas, peanuts, alfalfa, lentils, lupins, mesquite, carob, soybeans, tamarind, clover and vetch, nightshades (Solanaceae) including tomatoes, peppers, eggplants, potatoes, tomatillos, and ground cherries, cucurbits (Cucurbitaceae) including squash, pumpkins, zucchini, melons, gourds, and cucumbers, brassicas (Brassicaceae) including cabbage, broccoli, cauliflower, kale, collards, mustard, kohlrabi, turnips, radishes, canola, arugula, and cress, alliums (Amaryllidaceae) including onions, garlic, shallots, leeks, and chives, asters (Asteraceae) including artichokes, sunflowers, and salsify, grasses (Poaceae) including corn, rye, oats, wheat, sorghum, rice, and millet, umbels (Apiaceae and Umbeliferae) including carrots and parsnips, Amaranthaceae including chart, beets, spinach and amaranth, Polygonaceae including buckwheat, rhubarb, and sorrel, and Convolvulaceae including sweet potatoes. Other plant sources of protein include flax seed, quinoa, rice, rapeseed, mungbean, sunflower, cassava, corn, spelt, linseed, arrowroot, favabeans, nava beans, barley, seitan, tempeh, edamame, spelt, kamut, teff, hemp (e.g., seeds), chia seeds, sesame seeds, farro, emmer wheat, lotus root, taro, horse gram, yams, yuca, almonds, cashews, walnuts, pine nuts, pistachios, Brazil nuts, hazelnuts, macadamia nuts, and pecans. Proteins of algal, fungal, and/or bacterial origin can also be suitable; examples include yeast (e.g., nutritional yeast), chlorella, sea moss, cyanobacteria, and spirulina.

“Pea” includes pea varieties belonging to the Pisum genus and, more particularly, to the species sativum and aestivum. Mutant varieties include “r”, “rb,” “rug 3,” “rug 4,” “rug 5,” and “lam” (Heydley et al., Developing novel pea starches,” Proceedings of the Symposium of the Industrial Biochemistry and Biotechnology Group of the biochemical Society (1996), pp. 77-87.).

The shear-processed, plant-based protein can be prepared using any suitable physical processing means as known in the art. Examples of shear processing include, but are not limited to, homogenization, ball milling, jet milling, cryo-milling, kneading, and extrusion.

Homogenization is a process of making things uniform or similar. Homogenization can involve the use of high-speed, high-pressure, ultrasound, microfluidization, etc. High-pressure homogenization forces a liquid through a narrow nozzle at high pressure. A high shear stress or rate is established.

Ball milling uses media (balls) in a chamber to mill materials. The equipment used for ball milling include but are not limited to stirred ball mill and planetary ball mill. During the ball milling, the balls and particles of processed material (e.g., protein isolate) collide with each other and with the chamber walls, leading to the generation of high shear force and high energy input. Ball milling can be applied to solid, liquid, or semi-liquid systems.

Jet milling converts the potential energy of a compressible fluid into kinetic energy within the mill grinding chamber. This occurs when compressed gas is injected through specially designed nozzles.

Cryo-milling (e.g., cryogenic milling or grinding) uses liquid nitrogen (or other chilling agent or cryogen such as dry ice or liquid carbon dioxide) to lower the temperature of the material and/or the milling process. The material becomes brittle and volatile components are preserved.

Kneading involves the use of a high-shear mixer, such as a high shear reactor, a rotor-stator mixer, Sigma mixer, and high-shear homogenizer. Such kneading machines can be vertical or horizontal. They are used to emulsify, homogenize, disperse, grind, and/or dissolve mixtures with components in the same or different phases.

Extrusion involves the application of thermal and mechanical energy. The specifics of the extrusion equipment (e.g., die design, screw speed, back pressure, and dwell time) affect mixing and the application of thermal and mechanical energy. Heating or cooling can be used during pre-conditioning to raise or decrease the temperature of the mixture before it enters the extruder. The product can be further heated or cooled as it passes through the cylinder. Mechanical energy involves rotation of the screws and compression of the mixture as it is forced towards the die. Extrusion can be conducted at high or low temperatures (e.g., with a heating or cooling system) when it is needed to better control the properties of extruded materials.

The shear-processed, plant-based protein can be in the form of solid, semi-solid, aqueous dispersion, or other form. The aqueous dispersion of shear-processed, plant-based protein can be dehydrated by spray-drying (see, e.g., USPAPN 2022/0183337) or other dehydration method, such as freeze-drying, vacuum drying, or drum drying.

Further provided is a human food or animal feed product comprising the shear-processed, plant-based protein. The human food or animal feed product can be a PBMA product (e.g., crumbles, strips, slabs, steaks, cutlets, patties, nuggets, loafs, sausages, or meatballs). The product either (i) comprises a reduced amount of methylcellulose (or other polysaccharide gum), a crosslinking enzyme (e.g., transglutaminase), or both, where “reduced” refers to a decrease of at least 5%, 10%, 20%, 40%, or 80% compared with products without said shear-processed, plant-based protein, or (ii) does not comprise methylcellulose (or other polysaccharide gum), a crosslinking enzyme (e.g., transglutaminase), or both. There are multiple ways for making PBMA products. For example, continuous high-throughput injection molding can be used to produce such products (see, e.g., USPAPN 2023/0225361).

Further provided is a composition comprising at least one herb-spice with anti-pathogen and/or anti-spoilage properties, wherein, by shear processing, (i) the content of pathogenic microorganisms and/or spoilage microorganisms of the at least one herb-spice is decreased, (ii) the anti-pathogen property and/or anti-spoilage property of the at least one herb-spice is increased, or (iii) the content of pathogenic microorganisms and/or spoilage microorganisms of the at least one herb-spice is decreased, and the anti-pathogen property and/or anti-spoilage property of the at least one herb-spice is increased.

Log reduction is a mathematical term that is used to express the relative number of living microbes that are eliminated by an antimicrobial treatment, such as disinfection.

$$Log reduction = log 10 ( {N}_{0} / N )$$

Where.
N₀=number of microbial cells before treatment
N=number of microbial cells after treatment
   The number of microbial cells can be determined by different approaches, such as microbe count based on colony-forming units.

For example, a 1 log reduction corresponds to inactivating 90 percent of a target microbe with the microbe count being reduced by a factor of 10. A 2-log reduction indicates a 99 percent reduction, or microbe reduction by a factor of 100, and so on. The table below shows the chart of log reduction.

| Log Reduction | Reduction Factor | Percent Reduced |
|---|---|---|
| 1 | 10 | 90% |
| 2 | 100 | 99% |
| 3 | 1,000 | 99.9% |
| 4 | 10,000 | 99.99% |
| 5 | 100,000 | 99.999% |
| 6 | 1,000,000 | 99.9999% |

Further provided is a composition comprising at least one herb-spice with anti-pathogen and/or anti-spoilage properties, wherein, by shear processing, (i) the content of pathogenic microorganisms and/or spoilage microorganisms of the at least one herb-spice shows at least 1 log reduction, (ii) the anti-pathogen capability and/or anti-spoilage capability of the at least one herb-spice is increased by at least 1 log reduction, or (iii) the content of pathogenic microorganisms and/or spoilage microorganisms of the at least one herb-spice shows at least 1 log reduction, and the anti-pathogen capability and/or anti-spoilage capability of the at least one herb-spice is increased by at least 1 log reduction.

Further provided is a composition comprising at least one herb-spice with anti-pathogen and/or anti-spoilage properties, wherein, by shear processing, (i) the content of pathogenic microorganisms and/or spoilage microorganisms of the at least one herb-spice shows at least 1, 2, 3, 4, or 5 log reduction, (ii) the anti-pathogen capability and/or anti-spoilage capability of the at least one herb-spice is increased by at least 1, 2, 3, 4, or 5 log reduction, or (iii) the content of pathogenic microorganisms and/or spoilage microorganisms of the at least one herb-spice shows at least 1, 2, 3, 4, or 5 log reduction, and the anti-pathogen capability and/or anti-spoilage capability of the at least one herb-spice is increased by at least 1, 2, 3, 4, and 5 log reduction.

In certain embodiments, the at least one herb-spice is a whole spice. The shear processing can involve homogenization, milling, kneading, extrusion, or a combination of two or more thereof. The at least one herb-spice can have anti-pathogen and/or anti-spoilage properties against Listeria, E. coli, Salmonella, or their combinations, or other types of pathogenic or spoilage microorganisms or their combinations.

In this document, “herb-spice” indicates herb and/or spice. Not every herb is a spice, and not every spice is an herb. By “herb” is meant any plant or plant part that can be legally used for specific products such as food or beverages. By “spice” is meant any aromatic vegetable substance in the whole, broken, or ground form, including those substances which have been traditionally regarded as foods, such as onions, garlic and celery, whose significant function in food is seasoning or flavoring. The at least one herb-spice can be a whole herb or spice, a portion of a whole herb or spice, or a whole or a portion of a whole herb or spice that has been subjected to a natural or artificial loss of volatile and/or non-volatile components such as through storage, transportation, extraction, processing, or their combinations.

Shear processing can be a high-energy milling using a planetary ball mill, a stirred ball mill, a jet mill, a cryo-mill, or other types of mills, or can be homogenization, extrusion, kneading, or any type of processing that provides shear force to the treated material, including combinations of two or more of the foregoing. Desirably, the shear processing disrupts cells and releases and activates antimicrobial ingredients.

The at least one herb-spice can be oregano, rosemary, garlic, onion, allspice, thyme, cinnamon, tarragon, cumin, cloves, lemongrass, bay leaf, capsicum, marjoram, mustard, caraway, mint, sage, fennel, coriander, dill, nutmeg, basil, parsley, cardamon, pepper, ginger, anise seed, celery seed, lemon, lime, huacatay, turmeric, or a combination of two or more of the foregoing. For example, the at least one herb-spice can be rosemary, cloves, and cinnamon. The herb-spice composition can be used in various applications, such as, but not limited to, human food, animal feed, agricultural, pharmaceutical, and medical applications.

Other examples of herb-spices, which can be included in the composition, include, but are not limited to, Ajwain, carom seeds (Trachyspermum ammi), Akudjura (Solanum centrale), Alexanders (bullaSmyrnium olusatrum), Alkanet (Alkanna tinctoria), for red color, Alligator pepper, mbongo spice (mbongochobi), hepper pepper (Aframomum danielli, A. citratum, A. exscapum), Allspice (Pimenta dioica), Angelica (Angelica archangelica), Anise (Pimpinella anisum), Anise Hyssop (Agastache foeniculum), Aniseed myrtle (Syzygium anisatum), Annatto (Bixa orellana), Apple mint (Mentha suaveolens, Mentha x rotundifolia and Menthax villosa), Artemisia (Artemisia spp.), Asafoetida (Ferula assafoetida), Asarabacca (Asarum europaeum), Avens (Geum urbanum), Avocado leaf (Peresea americana), Barberry (Berberis vulgaris and other Berberis spp.), Basil, sweet (Ocimum basilicum), Basil, lemon (Ocimum x citriodorum), Basil, Thai (O. basilicum var. thyrsiflora), Basil, Holy (Ocimum tenuiflorum), Bay leaf (Laurus nobilis) Bay leaf, Indian, tejpat, malabathrum, Bcc balm (Monarda didyma), Boldo (Peumus boldus), Borage (Borago officinalis), Black cardamom (Amomum subulatum, Amomum costatum), Black mustard (Brassica nigra), Blue fenugreek, blue melilot (Trigonella caerulea), Brown mustard (Brassica juncea), Caraway (Carum carvi), Cardamom (Elettaria cardamomum), Catnip (Nepeta cataria), Cassia (Cinnamomum aromaticum), Cayenne pepper (Capsicum annuum), Celery leaf (Apiumi graveolens), Celery seed (Apiumi graveolens), Chervil (Anthriscus cerefolium), Chicory (Cichorium intybus), Chili pepper (Capsicum spp.), Chives (Allium schoenoprasum), Cicely, sweet cicely (Myrrhis odorata), Cilantro, coriander greens, coriander herb (Coriandrum sativum), Cinnamon, Indonesian (Cinnamomum burmannii, Cassia vera), Cinnamon, Saigon or Vietnamese (Cinnamomum loureiroi), Cinnamon, true or Ceylon (Cinnamomum verum, C. zeylanicum), Cinnamon, white (Canella winterana), Cinnamon myrtle (Blackhousia myrtifolia), Clary, Clary sage (Salvia sclarea), Clove (Syzygium aromaticum), Coriander seed (Coriandrum sativum), Costmary (Tanacetum balsamita), Cuban oregano (Plectranthus amboinicus), Cubeb pepper (Piper cubeba), Cudweed (Gnaphalium spp.), Culantro, culangot, long coriander (Eryngium foetidum), Cumin (Cuminum cyminum), Curry leaf (Murraya koenigii), Curry plant (Helichlysum_italicum), Dill seed (Anethum graveolens), Dill herb or weed (Anethum graveolens), Elderflower (Sambucus spp.), Epazote (Dysphonia ambrosioides), Fennel (Foeniculum vulgare), Fenugreek (Triganella foenum-graecum), File powder, gumbo file (Sassafras albidum), Fingerroot, krachai, temu kuntji (Boesenbergia rotunda), Galangal, greater (Alpinia galanga), Galangal, lesser (Alpinia officinarum), Galingale (Cyperus spp.), Garlic chives (Allium tuberosum), Ginger (Zingiber officinale), Ginger, torch, bunga siantan (Etlingera elatior), Golpar, Persian hogweed (Heracleum persicum), Grains of paradise (Aframomum melegueta), Grains of Selim, Kani pepper (Xylopia aethiopica), Horseradish (Armoracia rusticana), Houttuynia cordata, Huacatay, Mexican marigold, mint marigold (Tagetes minuta), Hyssop (Hyssopus officinalis), Indonesian bay leaf, daun salam (Syzygium polyanthum), Jasmine flowers (Jasminum spp.), Jimbu (Allium hypsistum), Juniper berry (Juniperus communis), Kaffir lime leaves, Makrud lime leaves (Citrus hystrix), Kala zeera (or kala jira), black cumin (Bunium persicum), Kawakawa seeds (Macropiper excelsum), Kencur, galangal, kenttur (Kaempferia galanga), Keluak, kluwctk, kepayang (Pangium edule), Kinh gioi, Vietnamese balm (Elsholtzia ciliara), Kokam seed (Garcinia indica), Korarima, Ethiopian cardamom, false cardamom (Aframomum corrorima), Koseret leaves (Lippia adoensis), Lavender (Lavandula spp.), Lemon balm (Melissa officinalis), Lemongrass (Cymbopogon citratus, C. flexuosus, and other Cymbopogon spp.), Lemon ironbark (Eucalyptus staigeriana), Lemon myrtle (Backhousia citriodora), Lemon verbena (Lippia citriodora), Leptotes bicolor, Lesser calamine (Calamintha nepeta), nipitella, nepitella, Licorice, liquorice (Glycyrrhiza glabra), Lime flower, linden flower (Tilia spp.), Lovage (Levisticum officinals), Mace (Myristica fragrans), Mahlab, St. Lucie cherry (Prunus mahaleb), Marjoram (Origanum majorana), Mastic (Pistacia lentiscus), Mint (Mentha spp.), Mountain horopito (Pseudowintera colorata) ‘Pepper-plant’, Musk mallow, abelmosk (Abelmoschus moschatus), Mustard, black, mustard plant, mustard seed (Brassica nigra), Mustard, brown, mustard plant, mustard seed (Brassica juncea), Mustard, white, mustard plant, mustard seed (Sinapis alba), Nigella, kalonji, black caraway, black onion seed (Nigella sativa), Njangsa, djansang (Ricinodendron heudelotii), Nutmeg (Myristica fragrans), Olida (Eucalyptus olida), Oregano (Origanum vulgare, O. heracleoticum, and other species) Orris root (Iris germanica, I. florentina, I. pallida), Pandan flower, kewra (Pandanus odoratissimus), Pandan leaf, screwpine (Pandanus amarylifolius) Paprika (Capsicum annuum), Paracress (Spilanthes acmella, Soleracea) (Brazil) Parsley (Petroselinum crispum), Pepper: black, white, and green (Piper nigrum) Pepper, Dorrigo, Pepper, long (Piper longum) Pepper, mountain, Cornish pepper leaf (Tasmannia Ianceolata), Peppermint (Mentha piperata), Peppermint gum leaf (Eucalyptus dives), Perilla, shiso (Perilla spp.), Peruvian pepper (Schinus molle), Brazilian pepper or Pink pepper (Schinus terebinthifolius), Quassia (Quassia amara), Rice paddy herb (Limnophila aromatic), Rosemary (Rosmarinus officinalis), Rue (Ruta graveolens) Safflower (Carthamus tinctorius), Saffron (Crocus sativus), Sage (Salvia officinalis) Saigon cinnamon (Cinnamomum loureiroi), Salad burnet (Sanguisorba minor) Salep (Orchis mascula), Sassafras (Sassafras albidum), Savory, summer (Satureja hortensis), Savory, winter (Satureja montana), Silphium, silphion, laser, laserpicium, lasarpicium, Shiso (Perilla frutescens) Sorrel (Rumex acetosa), Sorrel, sheep (Rumex acetosella), Spearmint (Mentha spicata) Spikenard (Nardostachys grandiflora or N. jatamansi), Star anise (Illicium verum) Sumac (Rhus coriaria), Sweet woodruff (Galium odoratism), Szechuan pepper, Sichuan pepper (Zanthoxylum piperitum), Tarragon (Artemisia dracunculus), Thyme (Thymus vulgaris), Thyme, lemon (Thymusxcit riodorus), Turmeric (Curcuma longa), Vanilla (Vanilla planifolia), Vietnamese cinnamon (Cinnamomum loureiroi) Vietnamese coriander (Persicaria odorata), Voatsiperifery (Piper borbonense), Wasabi (Wasabia japonica), Water-pepper, smartweed (Polygonum hydropiper) Watercress (Rorippa nasturtium-aquatica), Wattleseed (from about 120 spp. of Australian Acacia), White mustard (Sinapis alba), Wild thyme (Thymus serpyllum) Willow herb (Epilobium parviflorum), Wintergreen (Gaultheria procumbens) Wood avens, herb bennet (Geum urbanum), Woodruff (Gallium odoratum) Wormwood, absinthe (Artemisia absinthium, Yellow mustard (Brassica hirta=Sinapis alba), Za'atar (herbs from the genera Origanum, Calamintha, Thymus, and Satureja) Zedoary (Curcuma zedoaria).

The herb-spice composition can have an anti-pathogen and/or anti-spoilage effect, capability, or property. Pathogenic and/or spoilage microorganisms include, but are not limited to, bacteria (Bacillus cereus, Campylobacter jejuni, Clostridium botulinum, Clostridium perfringens, Cronobacter sakazakii, Escherichia coli, Listeria monocytogenes, Salmonella spp., Shigella spp., Staphylococcus aureus, Vibrio spp., and Yersinia enterocolitica), viruses (Hepatitis A and Noroviruses), and parasites (Cyclospora cayetanensis, Toxoplasma gondii, and Trichinella spiralis) (see, e.g., www[dot] ncbi[dot] nlm[dot] nih[dot] gov/pmc/articles/PMC6604998/and www[dot]foodsafety[dot]gov/food-poisoning/bacter-and-viruses). “Pathogenic and/or spoilage microorganisms” will be used herein to refer to bacteria, viruses, fungi, yeast (e.g., molds and yeast), protozoa, algae, and prions.

Food spoilage is a metabolic process that causes foods to be undesirable and/or unacceptable for human consumption. This may be due to changes in sensory characteristics, such as color, smell, taste and/or texture (see, e.g., microbenotes[dot]com/food-spoilage-microorganisms). Food is most commonly spoiled by bacteria, such as Gram-positive bacteria including S. aureus, Bacillus spp., Clostridium spp., lactic acid bacteria, Leuconostoc spp., Streptococcus spp., Brochothrix spp., Weissella spp., and Mycobacterium bovis, Gram-negative bacteria including Salmonella spp., Shigella, Vibrio spp., E. coli, Campylobacter jejuni, Yersinia enterocolitis, Brucella spp., Coxiella burnetti, Aeromonas spp., and Plesiomonas shigelloides.

The bacteria and viruses that cause the most illnesses, hospitalizations, and deaths in the United States include Campylobacter, Clostridium perfringens, Clostridium botulinum, E. coli, Listeria, Norovirus, and Salmonella. Other important bacteria that cause foodborne illnesses include but are not limited to Bacillus cereus, Shigella, Staphylococcus aureus, and Vibrio (see, e.g., www[dot]foodsafety[dot]gov/food-poisoning/bacteria-and-viruses). Examples of disease-causing viruses include but are not limited to Norovirus, Hepatitis A virus (HAV), Hepatitis E virus (HAE), Astrovirus (AstV), Rotavirus (RV), Coronavirus, and Sapovirus (SaV).

Fungi are the most abundant group of microorganisms that plays a role in food spoilage. Fungi include molds and yeasts. Molds are the most common food spoilage-causing microorganisms and include, but are not limited to, Mucor, Aspergillus spp., Rhizopus spp., Penicillium spp., Alternaria spp., Bothrytis, Byssochlamys, and Fusarium spp.

Compared to bacteria and molds, yeasts play a minor role in food spoilage. Yeasts that cause food spoilage include, but are not limited to, Zygosaccharomyces spp., Saccharomyces spp., Candida spp., and Dekkera spp.

Protozoa can cause foodborne disease. The most common protozoa are Giardia lamblia, Entamoeba histolytica, Cyclospora cavetanensis, Toxoplasma gondii, and Trichinella spiralis.

Algae can produce toxins in fish and other marine life. Upon consumption by humans, such toxins can cause foodborne illness. Examples of such algae include Gonvaulax catenella, Gonvaulax tamarensis, Gambierdiscus toxicus, Ptychodiscus brevis, Microcystis aeruginosa, and blue-green algae.

Prions can be transferred from non-human animals to humans upon consumption of infected meat and meat products, causing debilitating disease. Examples of such diseases include Bovine spongiform encephalopathies (BSE), scrapie, chronic wasting disease (CWD), and Creutzfeldt-Jacob disease.

In embodiments, the at least one herb-spice can have anti-pathogen and/or anti-spoilage properties, capabilities, or effects. The pathogenic and/or spoilage microorganisms include, but are not limited to Listeria, Salmonella, E. coli, or their mixtures, or other types of pathogenic or spoilage microorganisms or their combinations.

In view of the above, further provided is a product, such as a product for human or animal consumption as described above, further comprising the composition comprising at least one herb-spice with anti-pathogen and/or anti-spoilage properties. In certain embodiments, the composition comprising at least one herb-spice with anti-pathogen and/or anti-spoilage properties is present in an amount up to 5% by weight of the product.

The above-described product, such as a product for human or animal consumption as described above, can further comprise the aforementioned herb-spice composition, such as in an amount up to 20%, such as 1%, 2%, 3%, 4%, 5%, 10%, or 20% by weight of the product. The herb-spice composition can be added to a PBMA product in an amount of about 5%, 10%, 20%, 50%, 75%, 100%, 200%, 300%, or 400% of the protein content. Thus, such product can comprise protein to herb-spice in a ratio from 100%:0% to 20%:80%, for example.

The composition comprising at least one herb-spice with anti-pathogen and/or anti-spoilage properties can be used in other products for human or animal consumption (e.g., meat, dairy, fruits, vegetables, and processed foods). Other applications include agriculture (e.g., fungicide or pesticide), community/commercial/medical/home (e.g., cleaning surfaces, such as to reduce mold and antibiotic-resistant bacteria).

### EXAMPLES

The following examples serve to illustrate the present disclosure. The examples are not intended to limit the scope of the claimed invention in any way.

### Example 1

Physically Processed Pea Protein (PPPP) is More Hydrophobic than Non-Treated Pea Protein (Non-Treated PP).

PPPP #1 and PPPP #10 were generated using different homogenization and spray-drying conditions. To generate PPPP #1, aqueous dispersion of original pea protein isolate (non-treated PP) was subjected to high-pressure homogenization at 200 bars with 2 passes, and then the dispersion was spray-dried at inlet temperature of 120° C. and outlet temperature of 65° C. to collect PPPP #1 in powder form. To generate PPPP #10, aqueous dispersion of original pea protein isolate (non-treated PP) was subjected to high-pressure homogenization at 300 bars with 2 passes, and then the dispersion was spray-dried at inlet temperature of 150° C. and outlet temperature of 65° C. to collect PPPP #10 in powder form. As shown in FIG. 1, the hydrophobicity (hydrophobic index) value of PPPP #1 (93.3) was greater than that of PPPP #10 (82.8), and the hydrophobicity (hydrophobic index) values of PPPP #1 and PPPP #10 were both substantially greater than the hydrophobicity value of non-treated PP (44.5).

### Example 2

### High Hydrophobicity of PPPP Leads to Intensive Aggregation of Protein Particles.

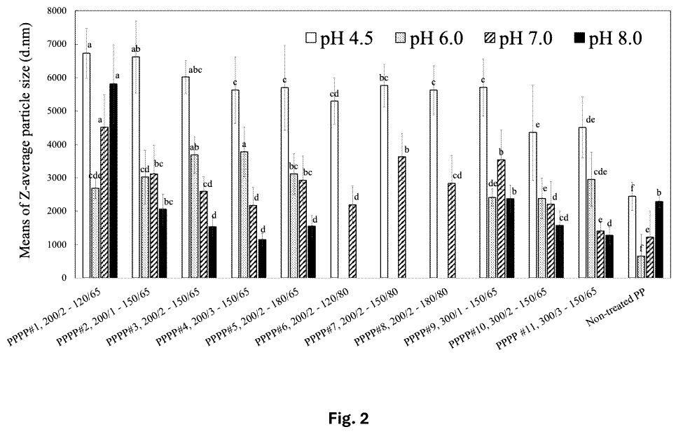

The Z-average particle size (d. nm) of eleven PPPP materials (PPPP #1 to PPPP #11) was compared with that of non-treated PP at different pH conditions. The results are shown in FIG. 2. At pH 4.5, the particle size of PPPP #1 was 6,732 nm as compared with 2,444 nm of non-treated PP. The particle size of other PPPP materials ranged from 4,357 to 6,621 nm, all greater than that of non-treated PP. At pH 6.0, the particle size of PPPP #1 was 2,681 nm, much greater than that of non-treated PP (660 nm). At pH 7.0, the particle size of PPPP #1 was 4,514 nm, much greater than that of non-treated PP (1,219 nm). At pH 8.0, the particle size of PPPP #1 (5,811 nm) was still greater than that of non-treated PP (2,291 nm). Among all PPPP materials, PPPP #1 showed the highest particle size at pH 4.5, 7.0, and 8.0. The hydrophobicity and particle size data indicated the strong capability of PPPP #1 to aggregate via hydrophobic interactions. FIG. 2 also shows that, at each pH value of pH 4.5, 6.0, or 7.0, the Z-average particle size value of each PPPP material was greater than that of non-treated PP.

### Example 3

### PPPP Increases the Integrity and Flexibility of PBMA Patties.

PBMA patties were prepared with (i) PPPP #1, (ii) non-treated PP, or (iii) methylcellulose (MC) as binder. The patty formulations of differently labeled patties contained:
(i) 2% MC: 38% textured pea protein (TPP), 2% MC, 10% fat, and 50% water;
(ii) 10% non-treated PP: 30% TPP, 10% non-treated PP, 10% fat, and 50% water;
(iii) 10% PPPP #1:30% textured pea protein, 10% PPPP #1, 10% fat, and 50% water;
(iv) 9% PPPP #1+1% rosemary: 30% textured pea protein, 9% PPPP #1, 1% milled rosemary, 10% fat, and 50% water;
(v) 9.5% PPPP #1+0.5% rosemary: 30% textured pea protein, 9.5% PPPP #1, 0.5% milled rosemary, 10% fat, and 50% water; or
(vi) 9.5% PPPP #1+0.5% cinnamon: 30% textured pea protein, 9.5% PPPP #1, 0.5% milled cinnamon, 10% fat, and 50% water.
   Both cooked and uncooked patties were subjected to three-point bend textural analysis. The results are shown in FIG. 3.

Peak force data showed that, compared with non-treated PP, MC or PPPP #1-containing binders increased the strength of uncooked patties. PPPP #1-containing binders also increased the strength of cooked patties, except for the PPPP #1-containing group that contained 1% milled rosemary.

Results in the distance till break point revealed the benefit of PPPP #1. The primary function of binders in patties is to increase the flexibility and integrity of products, making them more resistant to breaking and collapsing during handling and eating. As shown in FIG. 3, for uncooked patties, 2% MC as a binder led to significantly greater distance till break point than 10% non-treated PP, explaining the fact that MC has been very important in making commercial PBMA patties. Using 10% PPPP #1 further increased the distance till break point compared with 2% MC and 10% non-treated PP, suggesting the advantage of PPPP #1 as a binder. For cooked and cooled patties, the distance till break point of 2% MC was comparable to that of 10% non-treated PP. This suggests a disadvantage of MC for insufficiently holding the integrity of the patty after cooling; this is attributed to the melting of MC gel after cooling. In contrast, the distance till break point of PPPP #1 was significantly greater than that of 2% MC and 10% non-treated PP, suggesting the high capability of PPPP #1 to maintain the structural integrity of the patty after cooling. Therefore, 10% PPPP #1 provides better meat patty simulation than 2% MC. For most, if not all, commercial plant-based burger and patty products we have checked, 2% is the high limit of MC usage in formulations (i.e., methylcellulose appears after “contains 2% or less of” in the ingredient list).

The use of 0.5% or 1% milled spices did not compromise the functionality of PPPP #1 as a binder. FIG. 3 shows that, for uncooked patties, adding 0.5% of milled rosemary or milled cinnamon or 1% of milled rosemary at least achieved the distance till break point of the 10% PPPP #1 group. For cooked and cooled patties, adding milled spices led to a slight decrease of distance till break point; still, their distances till break point were in general significantly greater than that of 10% non-treated PP and 2% MC, except for the group that contained 1% milled rosemary. These results suggest that up to 1% of milled spice does not adversely affect the texture of PBMA patties when PPPP #1 is used as the binder.

### Example 4

### PPPP Stabilizes Shape of and Provides High Water- and Fat-Holding Capacities to Plant-Based Meat Alternative (PBMA) Products.

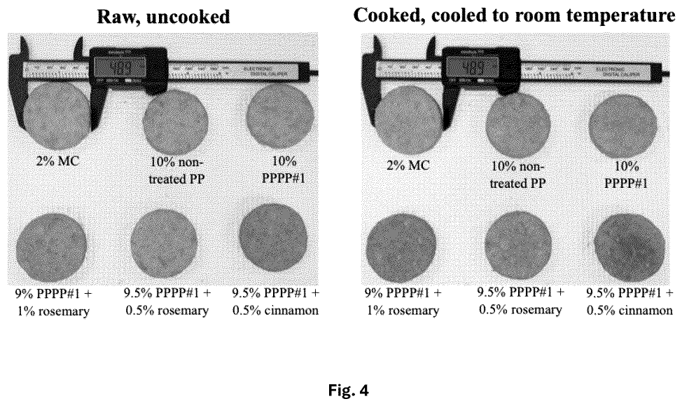

FIG. 4 shows the images of PBMA patties formulated using textured pea protein (TPP) and different binders. The formulations of PBMA patties were the same as those described in Example 3. There was no appreciable color difference among 2% MC, 10% non-treated PP, and 10% PPPP #1. Adding milled rosemary or milled cinnamon has slightly changed the color, but the color differences can be conveniently masked by red colorings conventionally used in commercial PBMA patty products. The size of each type of patty did not change, suggesting their shape stability and high water- and fat-holding capacities.

### Example 5

PPPP reduces the gaps between textured protein particles and binder.

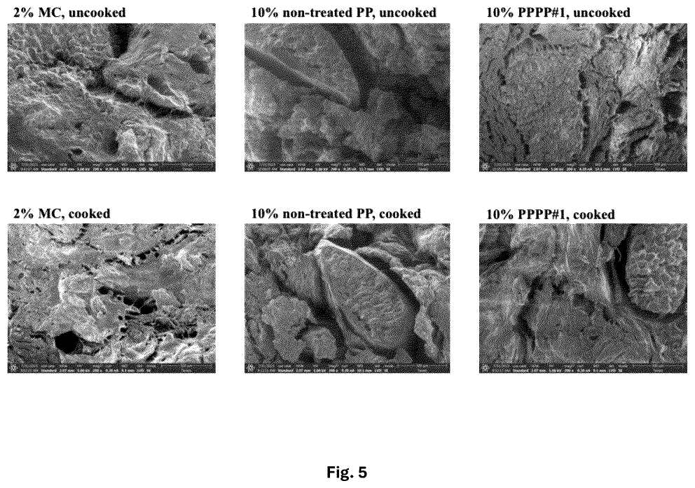

FIG. 5 shows the SEM images of PBMA patty prototypes formulated using 2% MC, 10% non-treated PP, or 10% PPPP #1 as binder, either before or after cooking. The impact of cooking on the microstructure did not seem to be substantial; however, different types of binder led to different microstructure. Use of 2% MC as binder very much filled the gaps among textured pea protein particulates due to the high swelling of MC. For both uncooked and cooked patties, the use of 10% non-treated PP as binder left large gaps in the matrix. In contrast, the gaps in matrix were much smaller with 10% PPPP #1 as binder. These comparisons suggest that while the swelling of protein was less than that of MC, PPPP #1 showed greater adhesiveness and cohesiveness than non-treated PP.

### Example 6

### High-Energy Milling Increases Antimicrobial Effects of Spices

Antibacterial tests on ten spices, including turmeric, thyme, paprika, rosemary, garlic, onion, cloves, cumin, cinnamon, and oregano, were carried out. The hypothesis was that high-energy milling, such as ball-milling (e.g., using a planetary ball mill) can effectively sterilize whole spices and increase their antimicrobial efficacies. Tests included: (1) a background microbial test using non-selective media, (2) an initial Listeria test of all 10 spices, (3) a Salmonella test using selected spices, and (4) an additional Listeria test using selected spices.

Microbial background test. Original and milled forms of spices were used. The spices were individually dispersed in phosphate-buffered saline (PBS), transferred to a 96-well microplate, incubated for 24 hrs, and tested in non-selective plates with five dilutions (i.e., original dispersion and 1/10, 1/100, 1/1,000, and 1/10,000 dilutions). The plating results showed that some original spices contained high counts of microorganisms. For original spices, microorganisms were found in 1/10,000 dilutions of turmeric, original dispersions for paprika, 1/100 dilutions for garlic, 1/100 dilutions for onion, 1/10 dilutions for cloves, and 1/10 dilutions for cinnamon. For their milled counterparts, microorganisms were not found for turmeric, paprika, onion, cloves, and cinnamon in any dilution, and were found for garlic only in original dispersion. High-energy milling, such as ball-milling, effectively sterilized the spices.

### Example 7

### Anti-Listeria and Anti-Salmonella Effects of Spices

Bacterial counts for original and milled spices were determined. The results are shown in Table 1.

TABLE 1
Bacterial counts for original and milled spices

| | | Listeria monocytogenes F4244, log(CFU/mL) | | | | | | | |
|---|---|---|---|---|---|---|---|---|---|
| | | (log reduction) | | | | Salmonella enteritidis (SP-1), log(CFU/mL) | | | |
| | Spice | | Milled | | | (log reduction) | | | |
| | in | | | With | | | Milled | | |
| | PBS, | | Spice | gum | With pea | | Spice | With gum | With pea |
| Spice | % | Original | alone | arabic | protein | Original | alone | arabic | protein |
| Turmeric | 5 | 2.4 | 0 | 2.7 | NP* | 7.2 | 6.3 | 7.0 | NP |
| | | (0.7) | (>3.1) | (2.4) | | (promote) | (promote) | (~inert) | |
| Thyme | 5 | 2.6 | 2.6 | 2.9 | NP | 4.4 | 3.1 | 5.3 | NP |
| | | (0.5) | (0.5) | (2.2) | | (~inert) | (1.1) | (1.8) | |
| Rosemary | 1 | 0 | 0 | NP | 0 | 4.4 | 2.2 | NP | 5.3 |
| | | (>3.1) | (>3.1) | | (>6.6) | (~inert) | (2.0) | | (2.2) |
| Cloves | 2 | 1.8 | NP | 0 | NP | 0 | NP | 0 | NP |
| | | (1.3) | | (>5.1) | | (>4.2) | | (>7.1) | |
| Cinnamon | 1 | 0 | 0 | NP | 2.8 | 0 | 0 | NP | 2.7 |
| | | (>3.1) | (>3.1) | | (3.8) | (>4.2) | (>4.2) | | (4.8) |
| Oregano | 1 | 2.7 | 2.6 | NP | 2.9 | 7.3 | 4.4 | NP | 7.5 |
| | | (0.4) | (0.5) | | (3.7) | (promote) | (~inert) | | (~inert) |
| Control, | 0 | 3.1 | | | | 4.2 | | | |
| inoculum- | | | | | | | | | |
| only | | | | | | | | | |
| Control, | 0 | | | 5.1 | | | | 7.1 | |
| inoculum + | | | | | | | | | |
| gum arabic | | | | | | | | | |
| Control, | 0 | | | | 6.6 | | | | 7.5 |
| inoculum + | | | | | | | | | |
| pea protein | | | | | | | | | |

*NP: material not prepared; underlines indicate substantially enhanced efficacy (i.e., log reduction compared with individual controls) due to high-energy milling.

Compared with “inoculum-only” control, both gum arabic (in the “inoculum+gum arabic” control) and pea protein (in the “inoculum+pea protein” control) promoted the growth of Listeria and Salmonella through providing nutrients needed for bacterial growth. Turmeric, thyme, rosemary, cloves, and oregano, either milled alone or with milling agent (gum arabic or pea protein), showed increased antibacterial efficacies. In general, spices showed stronger antibacterial efficacy against Listeria than Salmonella. However, cloves and cinnamon showed similar or stronger efficacies against Salmonella. Rosemary is very strong against Listeria but much weaker against Salmonella. Milled turmeric and oregano had appreciable efficacies against Listeria, but they were either inert with or promoted Salmonella growth.

### Enumerated Embodiments

EE1. An aqueous dispersion of a shear-processed, plant-based protein, wherein, when the pH of the aqueous dispersion is about 4.5 to about 8, the shear-processed, plant-based protein forms particles or aggregates with a Z-average particle size greater than 500 nm.

EE2. The aqueous dispersion of EE1, wherein the plant-based protein is pea protein.

EE3. The aqueous dispersion of EE1 or EE2, wherein the plant-based protein is prepared using a process comprising a high-shear treatment.

EE4. The aqueous dispersion of EE3, wherein the high-shear treatment is homogenization, milling, kneading, extrusion, or a combination of two or more thereof.

EE5. A shear-processed, plant-based protein, which, when dispersed in an aqueous solvent at a pH of about 4.5 to about 8, forms particles or aggregates with a Z-average particle size greater than 500 nm.

EE6. The shear-processed, plant-based protein of EE5, which is pea protein.

EE7. The shear-processed, plant-based protein of EE5 or EE6, wherein the plant-based protein is prepared using a process comprising a high-shear treatment.

EE8. The shear-processed, plant-based protein of EE7, wherein the high-shear treatment is homogenization, milling, kneading, extrusion, or a combination of two or more thereof.

EE9. A human food or animal feed product comprising the shear-processed, plant-based protein of EE5 or EE6.

EE10. The human food or animal feed product of EE9, which is a plant-based meat alternative product.

EE11. The human food or animal feed product of EE9 or EE10, which (i) comprises a reduced amount of methylcellulose (or other polysaccharide gum), a reduced amount of a crosslinking enzyme, or both, where “reduced” refers to a decrease of at least about 5%, 10%, 20%, 40%, or 80% compared with products without said shear-processed, plant-based protein, or (ii) does not comprise methylcellulose (or other polysaccharide gum), a crosslinking enzyme, or both.

EE12. The human food or animal feed product of EE11, wherein the crosslinking enzyme is transglutaminase.

EE13. A composition comprising at least one herb-spice with anti-pathogen and/or anti-spoilage properties, wherein, by shear processing, (i) the content of pathogenic microorganisms and/or spoilage microorganisms of the at least one herb-spice is decreased, (ii) the anti-pathogen property and/or anti-spoilage property of the at least one herb-spice is increased, or (iii) the content of pathogenic microorganisms and/or spoilage microorganisms of the at least one herb-spice is decreased, and the anti-pathogen property and/or anti-spoilage property of the at least one herb-spice is increased.

EE14. The composition of EE13, wherein, by shear processing, (i) the content of pathogenic microorganisms and/or spoilage microorganisms of the at least one herb-spice shows at least 1 log reduction, (ii) the anti-pathogen capability and/or anti-spoilage capability of the at least one herb-spice is increased by at least 1 log reduction, or (iii) the content of pathogenic microorganisms and/or spoilage microorganisms of the at least one herb-spice shows at least 1 log reduction, and the anti-pathogen capability and/or anti-spoilage capability of the at least one herb-spice is increased by at least 1 log reduction.

EE15. The composition of EE13, wherein, by shear processing, (i) the content of pathogenic microorganisms and/or spoilage microorganisms of the at least one herb-spice shows at least 1, 2, 3, 4, or 5 log reduction, (ii) the anti-pathogen capability and/or anti-spoilage capability of the at least one herb-spice is increased by at least 1, 2, 3, 4, or 5 log reduction, or (iii) the content of pathogenic microorganisms and/or spoilage microorganisms of the at least one herb-spice shows at least 1, 2, 3, 4, or 5 log reduction, and the anti-pathogen capability and/or anti-spoilage capability of the at least one herb-spice is increased by at least 1, 2, 3, 4, and 5 log reduction.

EE16. The composition of EE13, wherein the at least one herb-spice is a whole herb-spice or a fraction of a whole herb-spice.

EE17. The composition of EE13, wherein shear processing involves homogenization, milling, kneading, extrusion, or a combination of two or more thereof.

EE18. The composition of EE13 or EE14, wherein the at least one herb-spice has anti-pathogenic and/or anti-spoilage properties against Listeria, E. coli, Salmonella, or their combinations, or other types of pathogenic or spoilage microorganisms or their combinations.

EE19. The composition of any one of EE13-EE16, wherein the at least one herb-spice is oregano, rosemary, garlic, onion, allspice, oregano, thyme, cinnamon, tarragon, cumin, cloves, lemongrass, bay leaf, capsicum, marjoram, mustard, caraway, mint, sage, fennel, coriander, dill, nutmeg, basil, parsley, cardamon, pepper, ginger, anise seed, celery seed, lemon, lime, huacatay, turmeric, or a combination of two or more of the foregoing.

EE20. The composition of any one of EE13-EE16, wherein the at least one herb-spice is rosemary, cloves, cinnamon, or their combinations.

EE21. A product for human or animal consumption comprising the composition of any one of EE13-EE20.

EE22. The human food or animal feed product of any one of EE9-EE12, which further comprises the composition of EE21.

EE23. The human food or animal feed product of EE22, wherein the composition of EE21 is present in an amount up to 5% by weight of the product.

The term “about” as used herein can allow for a degree of variability in a value or range, for example, within 10%, within 5%, or within 1% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation.

Any use of section headings and subheadings is solely for ease of reference and is not intended to limit any disclosure made in one section to that section only; rather, any disclosure made under one section heading or subheading is intended to constitute a disclosure under each and every other section heading or subheading.

Various modifications and variations of the described compositions, methods, and uses of the technology will be apparent to those skilled in the art without departing from the scope and spirit of the technology as described. Although the technology has been described in connection with specific exemplary embodiments, the invention as claimed should not be unduly limited to such specific embodiments. Indeed, various modifications of the described modes for carrying out the invention that are obvious to those skilled in the art are intended to be within the scope of the following claims.

The terms and expressions, which have been employed, are used as terms of description and not of limitation. In this regard, where certain terms are defined and are described or discussed elsewhere, the definitions and all descriptions and discussions are intended to be attributed to such terms. There also is no intention in the use of such terms and expressions of excluding any equivalents of the features shown and described or portions thereof.

Further, all publications and patents mentioned herein are incorporated by reference in their entireties for all purposes. In the event of inconsistent usages between this document and those documents so incorporated by reference, the usage in the incorporated reference should be considered supplementary to that of this document; for irreconcilable inconsistencies, the usage in this document controls.

What is claimed is:

1. An aqueous dispersion of a shear-processed, plant-based protein, wherein, when the pH of the aqueous dispersion is about 4.5 to about 8, the shear-processed, plant-based protein forms particles or aggregates with a Z-average particle size greater than 500 nm.

2. The aqueous dispersion of claim 1, wherein the plant-based protein is pea protein.

3. The aqueous dispersion of claim 1, wherein the plant-based protein is prepared using a process comprising a high-shear treatment.

4. The aqueous dispersion of claim 3, wherein the high-shear treatment is homogenization, milling, kneading, extrusion, or a combination of two or more thereof.

5. A shear-processed, plant-based protein, which, when dispersed in an aqueous solvent at a pH of about 4.5 to about 8, forms particles or aggregates with a Z-average particle size greater than 500 nm.

6. The shear-processed, plant-based protein of claim 5, which is pea protein.

7. The shear-processed, plant-based protein of claim 5, wherein the plant-based protein is prepared using a process comprising a high-shear treatment.

8. The shear-processed, plant-based protein of claim 7, wherein the high-shear treatment is homogenization, milling, kneading, extrusion, or a combination of two or more thereof.

9. A human food or animal feed product comprising the shear-processed, plant-based protein of claim 5.

10. The human food or animal feed product of claim 9, which is a plant-based meat alternative product.

11. The human food or animal feed product of claim 9, which (i) comprises a reduced amount of methylcellulose or other polysaccharide gum, a reduced amount of a crosslinking enzyme, or both, or (ii) does not comprise methylcellulose (or other polysaccharide gum), a crosslinking enzyme, or both.

12. The human food or animal feed product of claim 11, wherein the amount of methylcellulose or other polysaccharide gum, the amount of the crosslinking enzyme, or both is reduced by at least about 5%, 10%, 20%, 40% or 80% compared with a product without said shear-processed, plant-based protein.

13. The human food or animal feed product of claim 11, wherein the crosslinking enzyme is transglutaminase.

14. A composition comprising at least one herb-spice with anti-pathogen and/or anti-spoilage properties, wherein, by shear processing, (i) the content of pathogenic microorganisms and/or spoilage microorganisms of the at least one herb-spice is decreased, (ii) the anti-pathogen property and/or anti-spoilage property of the at least one herb-spice is increased, or (iii) the content of pathogenic microorganisms and/or spoilage microorganisms of the at least one herb-spice is decreased, and the anti-pathogen property and/or anti-spoilage property of the at least one herb-spice is increased.

15. The composition of claim 14, wherein, by shear processing, (i) the content of pathogenic microorganisms and/or spoilage microorganisms of the at least one herb-spice shows at least 1 log reduction, (ii) the anti-pathogen capability and/or anti-spoilage capability of the at least one herb-spice is increased by at least 1 log reduction, or (iii) the content of pathogenic microorganisms and/or spoilage microorganisms of the at least one herb-spice shows at least 1 log reduction, and the anti-pathogen capability and/or anti-spoilage capability of the at least one herb-spice is increased by at least 1 log reduction.

16. The composition of claim 14, wherein, by shear processing, (i) the content of pathogenic microorganisms and/or spoilage microorganisms of the at least one herb-spice shows at least 1, 2, 3, 4, or 5 log reduction, (ii) the anti-pathogen capability and/or anti-spoilage capability of the at least one herb-spice is increased by at least 1, 2, 3, 4, or 5 log reduction, or (iii) the content of pathogenic microorganisms and/or spoilage microorganisms of the at least one herb-spice shows at least 1, 2, 3, 4, or 5 log reduction, and the anti-pathogen capability and/or anti-spoilage capability of the at least one herb-spice is increased by at least 1, 2, 3, 4, and 5 log reduction.

17. The composition of claim 14, wherein the at least one herb-spice is a whole herb-spice or a fraction of a whole herb-spice.

18. The composition of claim 14, wherein shear processing involves homogenization, milling, kneading, extrusion, or a combination of two or more thereof.

19. The composition of claim 14, wherein the at least one herb-spice has anti-pathogenic and/or anti-spoilage properties against Listeria, E. coli, Salmonella, or their combinations.

20. The composition of claim 14, wherein the at least one herb-spice is oregano, rosemary, garlic, onion, allspice, oregano, thyme, cinnamon, tarragon, cumin, cloves, lemongrass, bay leaf, capsicum, marjoram, mustard, caraway, mint, sage, fennel, coriander, dill, nutmeg, basil, parsley, cardamon, pepper, ginger, anise seed, celery seed, lemon, lime, huacatay, turmeric, or a combination of two or more of the foregoing.

21. The composition of claim 14, wherein the at least one herb-spice is rosemary, cloves, cinnamon, or their combinations.

22. A product for human or animal consumption comprising the composition of claim 14.

23. The human food or animal feed product of claim 9, which further comprises the composition of claim 14.

24. The human food or animal feed product of claim 22, wherein the composition of claim 14 is present in an amount up to 5% by weight of the product.
